(19) United States
(12) Patent Application Publication
(10) Pub. No.: US 2024/0068207 A1
(43) Pub. Date: Feb. 29, 2024

(54) WATER FLOW ANTI-TAMPERING AND ANTI-THEFT DEVICE

(71) Applicants: Eli AMAR, Rechovot (IL); Mati SAMIMI GOLAN, Modieen Macabim Reute (IL); Shay ZBEDA, Ashkelon (IL)

(72) Inventors: Eli AMAR, Rechovot (IL); Mati SAMIMI GOLAN, Modieen Macabim Reute (IL); Shay ZBEDA, Ashkelon (IL)

(21) Appl. No.: 18/271,064

(22) PCT Filed: Jan. 6, 2022
(86) PCT No.: PCT/IL2022/050026

§ 371 Date: Jul. 6, 2023

Related U.S. Application Data
(63) Continuation of application No. 63/134,359, filed on Jan. 6, 2021.

(51) Int. Cl. E03B 9/06; F16K 35/00

(52) U.S. Cl. CPC E03B 9/06; F16K 35/00

(57) ABSTRACT

An anti-tampering mechanism for a fire hydrant that blocks inflow of fluids and materials through the pamper outlet into the lower barrel of the hydrant and to the water main. This mechanism comprises a modular valve, which stem extends only through the top barrel of the hydrant, and is in mechanical engagement and disengagement with a bottom seat that closes the top opening of the lower barrel. Thus, this mechanism blocks tampering with the water in both closed and open states of the valve. Further, the fire hydrant comprises a monitoring and anti-theft mechanism that comprises fluid flow sensors, wireless communication means and electronics accommodated in a housing that is attached to the lower barrel and and protectively enveloping them against tampering, vandalism and sabotaging.

### TECHNICAL FIELD

The present invention pertains to a water flow device for protecting against tampering with and steeling water. In particular, the invention is a fire hydrant that comprises anti-theft and anti-tampering mechanisms for preventing theft of water and introducing hazardous chemicals into the water stream that flows through the hydrant.

### BACKGROUND

Water theft and water tampering are two major hazards that require proper protection means for water reserves, ducts, channels and hydrants, especially when water supply for mass populations is concerned. Among these are fire hydrants, which are easily accessible on city streets for obvious reasons and, therefore, require improved protection and monitoring. Current solutions mainly concentrate on monitoring the faucet of the fire hydrant and alarming against any attempts to break or open it for illegal use.

Tampering with water flow through fire hydrants is also considered a possible hazard. Current fire hydrants are installed in the public space to be accessible in urgent events, when large amounts of water are necessary to put down fires. Such hydrants are susceptible to tampering with for unlawful use of water. Access to the water that flows through them is relatively easy and only requires relatively simple equipment to connect to their exit opening. The exit opening also makes it possible to introduce hazardous chemicals into the water, accidentally or intentionally. These actions are possible, because the current mechanism inside the hydrants that opens water flow enables a bi-directional passage for water flow when the hydrant's valve is opened.

The mechanism for shutting and opening the passage for water flow in current hydrants comprises a single solid piece with a valve plate at its bottom and a vertical screw, which is connected to a revolving opening and shutting valve at the top of the hydrant. The valve plate blocks the passage when it blocks the bottom of the hydrant through which water flows into the hydrant from the municipal water pipe system. When the valve plate is lifted up by the valve, water may flow from the water pipe system into the bottom of the hydrant and out through its pamper outlet. However, in such configuration the passage allows bi-directional flow of fluids into and out of the hydrant, so that fluids containing hazardous materials may be streamed from the pamper outlet into the water flow and down into the water in the municipal water pipe system. Also, water may be stolen through the hydrant by connecting to its pamper outlet or valve at the top when in open state.

The basic mechanism of a typical hydrant of the current art is illustrated in FIG. 1A. As shown, a valve mechanism includes a valve rod that extends along the upper and lower barrels of the hydrant body and a valve head and lower plate at its ends. As the valve opens the path from to the water base that connects to the water main and the pamper outlet the valve plate is lifted up and opens a passage for inflow of fluids from the pamper outlet into the water main. Such fluids may contain hazardous and/or poisonous materials that may harm large populations.

It is, therefore, an object of the present invention to provide a fire hydrant that comprises an anti-tampering mechanism that blocks inflow of fluids, particularly hazardous fluids and materials from the pamper outlet through the hydrant down into the water main.

It is yet another object of the present invention to provide means for monitoring and measuring water flow and alarming against potential attempts of water theft and water tampering in fire hydrants.

It is yet another object of the present invention to provide a housing shielding envelope with certain geometry, with various alerting means in order to provide a protection from tampering, sabotaging and vandalizing the water monitoring means inside the housing.

It is still yet another object of the present invention to provide wireless communication within the inner space of the housing for communicating with various external control and database units through the housing envelope shield.

It is yet another object of the present invention to provide low cost water flow monitoring and alarming against water theft, tampering and sabotaging device that comprises high volume reproducible production capabilities with versatile geometrical shapes and sizes customized for different geometrical shapes, sizes and diameters of fire hydrants, water pipes, channels and ducts with a simple and reliable installation and assembly of its electronic and mechanical parts.

This and other objects and embodiments of the invention shall become apparent as the description proceeds.

### SUMMARY

In one aspect, the present invention provides a solution for these anti-theft and anti-tampering dangers with a hydrant that comprises a water flow monitoring system, which may be installed on or inside the hydrant and a modular non-return valve, which is installed inside the hydrant.

The anti-tampering mechanism essentially comprises a modular valve that disconnects the solid connection between the valve stem and lower valve plate, extends the valve stem only along the upper barrel of the hydrant and forms an engagement and disengagement mechanism of the valve stem that applies on and releases off pressure on the valve plate. This anti-tampering mechanism is configured to block inflow of fluids from the pamper outlet into the hydrant and through it to the water main either by hermetically blocking the passage to the lower barrel with the valve plate or resisting inflow with fluid pressure that is sufficiently strong to lift the valve plate and valve stem up and stream through the pamper outlet. Further, the valve stem comprises a flexible mechanism that absorbs the pressure that the upstream of the water pressure in the lower barrel generates. Such mechanism may be a spring that wraps around and is fixed to the valve stem. This ensures soft absorption of shocks and prevents the solid parts of the valve stem from hitting and damaging each other.

In one embodiment, the anti-tampering mechanism for fire hydrants provides a solution to a hydrant with a single bonnet, a double bonnet or a multi-bonnet with a plurality of valves, for example 6-8 valves.

Further, the anti-theft mechanism is located at the top part of the hydrant and in one particular embodiment provided with a pipe that carries it. In a certain application of the anti-theft mechanism, this pipe is between 12 and 23 cm long. In one aspect, the present invention comprises an anti-theft and water flow monitoring system as described in U.S. application Ser. No. 16/088,409, which is incorporated in its entirety in this application by reference.

In particular, the anti-theft mechanism for the fire hydrant comprises water flow sensors for external monitoring of water flow in said water conducting channel, where the water flow sensors comprising controllers for controlling and supervising operation of the water flow sensors; a communication module for wirelessly communicating signals from the water flow sensors to a remote control unit; and a housing for accommodating the water flow sensors and communication module and protectively enveloping them against tampering, vandalism and sabotaging.

Further, the anti-theft mechanism comprises a controller for controlling and supervising operation of the water flow sensors. Further, the anti-tampering mechanism comprises a water flow monitoring device comprising: ultrasonic sensors for external monitoring of water flow in a fire hydrant, where the ultrasonic sensors comprise controllers for controlling and supervising operation of the water flow sensors; communication module for wirelessly communicating signals from the ultrasonic sensors to a remote control unit; and a housing for accommodating the ultrasonic sensors and communication module and protectively enveloping them against tampering, vandalism and sabotaging.

Further, the water flow monitoring device comprises a controller for controlling and supervising operation of the ultrasonic sensors. The housing is made of composite material, where the composite material comprises fiberglass and polyester. Further, the composite material comprises additives selected from plasticizers, softeners, UV absorbers, static charge neutralizing fillers and flame retardants. The anti-theft mechanism further comprises electro-mechanical switches attached to said screws of said housing. The housing is fabricated form martial which is partially or fully transparent to cellular and wireless short wavelength communication ranges.

In one embodiment, the flow sensors are non-invasive sensor, where particularly they are ultrasonic sensors installed on outer surface of said water conducting channel. In another embodiment, the water flow sensors are invasive sensors, particularly selected from visual or IR camera, said camera is configured to be introduced into volume of the water conducting channel and monitor water flow.

The anti-tampering modular non-return valve is illustrated in the appended drawings and described in their corresponding accompanying descriptions.

### BRIEF DESCRIPTION OF THE DRAWINGS

FIG. 1 illustrates a side view schematics of a fire hydrant.

FIG. 2 illustrates a second side view schematics of a fire hydrant.

FIG. 3 illustrates front view schematics of a fire hydrant with the anti-tampering mechanism.

FIG. 4 illustrates a rear view schematics of a fire hydrant with the installed anti-tampering mechanism.

FIG. 5 illustrates a rear cross-section view of the fire hydrant.

FIG. 6 illustrates a side cross-section of the fire hydrant that shows the different parts of the anti-tampering mechanism.

FIG. 7 illustrates a top view of the fire hydrant with the part of the anti-tampering mechanism that connects to the valve.

FIG. 8 illustrates a top cross section of the anti-tampering mechanism at the location in the fire hydrant that accommodates it.

FIG. 9 illustrates a double-bonnet hydrant with anti-tampering and anti-theft mechanisms.

FIG. 10 illustrates upper section of a double-bonnet hydrant with the interface between the anti-tampering mechanism and the main valve.

FIGS. 11-13 illustrate front and rear parts of the housing of anti-theft mechanism that is mounted on the hydrant lower barrel.

### DETAILED DESCRIPTION OF THE DRAWINGS

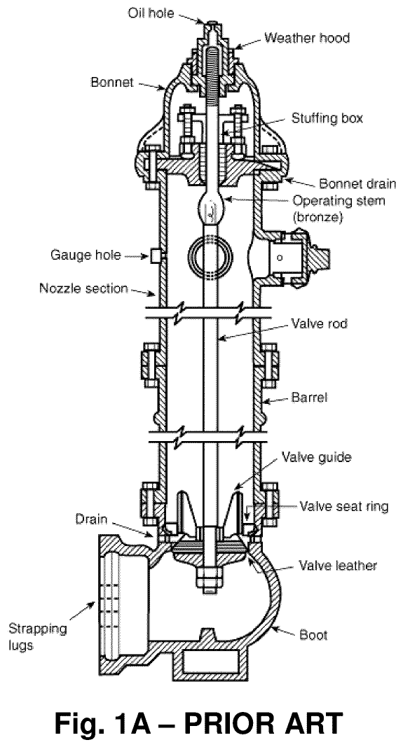

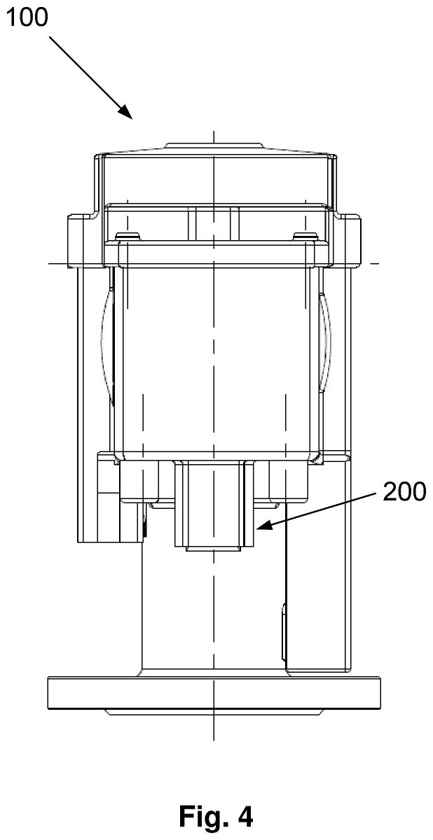

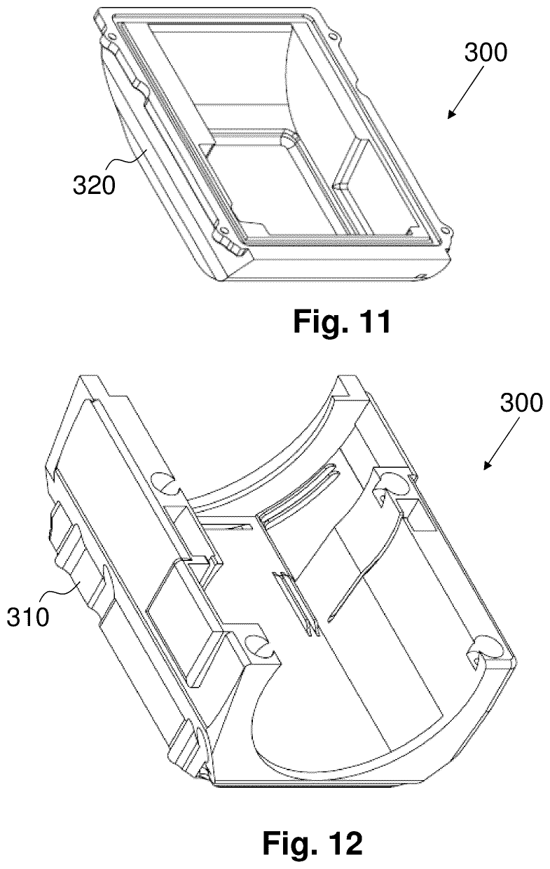

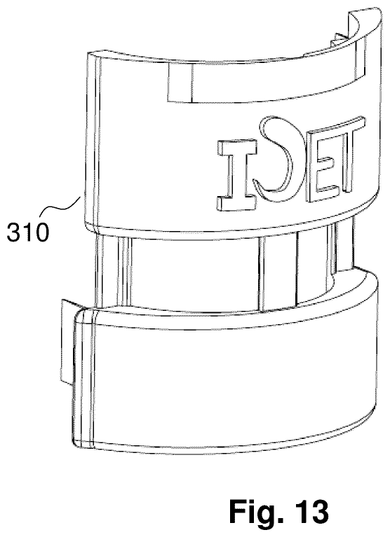

FIGS. 1-18 illustrate the aspects and parts of the anti-tampering, anti-theft hydrant of the invention, and will be referred to as needed in the following description. FIG. 1 illustrates a side view schematics of a fire hydrant 100 with a top bonnet 170 and a pumper outlet 120 for water. The hydrant is connected to a municipal or any other public water main pipe system at its base, where water from the main 135 flows up and into the hydrant from the base, when the operating open top, hollow valve stem 280 and bottom seat 210 (see FIG. 5), which are reconfigured to comprise an anti-tampering mechanism 200, are lifted up.

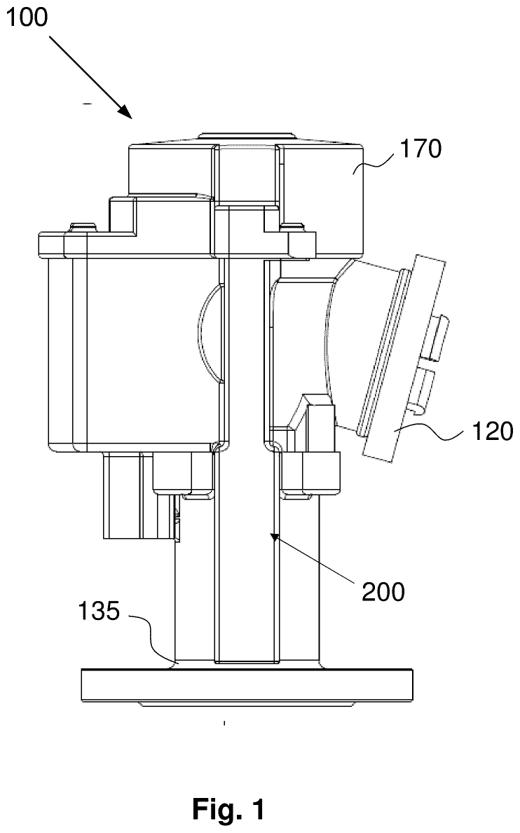

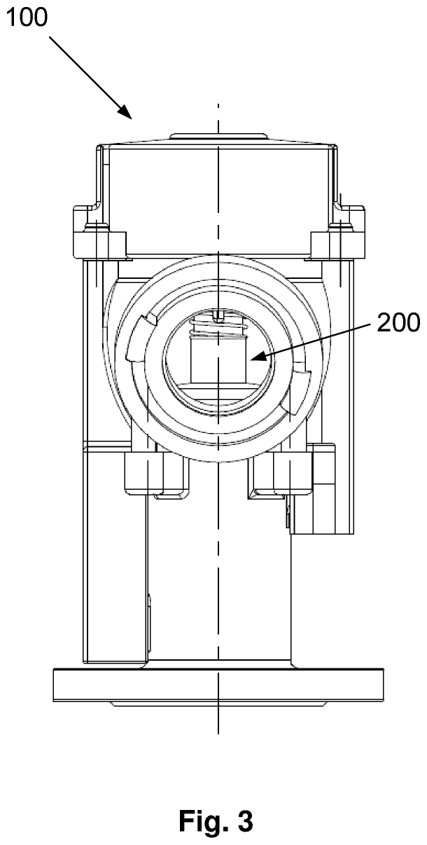

FIG. 2 illustrates a second side view schematics of a fire hydrant 100, and FIG. 4 illustrates a rear view schematics of a fire hydrant 100 with the installed anti-tampering mechanism 200.

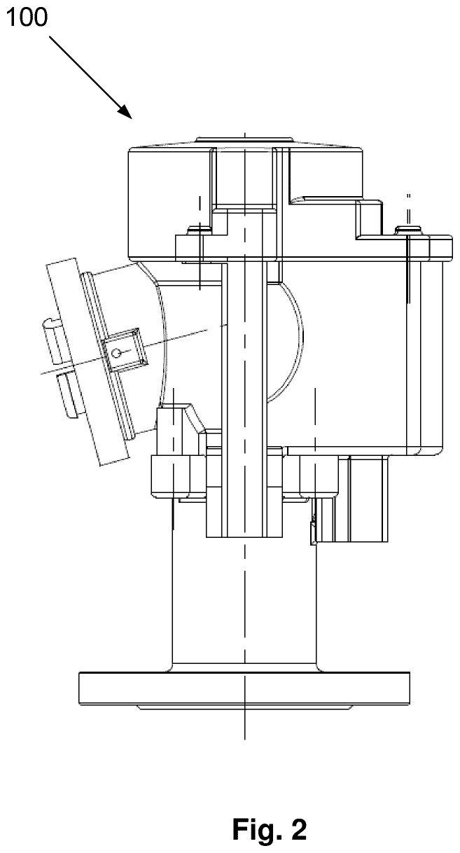

FIG. 3 illustrates a front view schematics of a fire hydrant 100 with the anti-tampering mechanism 200 installed within. Mechanism 200 is a modular, non-return valve that is located inside the hydrant along the length of the upper and lower barrels of the hydrant and connects to a valve at the top and engages with a base 135 that is in fluid communication with the water main at the bottom (shown in FIG. 1).

FIG. 5 illustrates a rear cross-section view of the fire hydrant 100 that shows the different elements of the anti-tampering mechanism 200. The anti-tampering mechanism is modular and comprises the following parts: a valve head 240, an abutment 270 for the valve head, a revolving screw 220, a spring 230, an open top, hollow valve stem 280, a valve plate 250 and a bottom seat 210.

As the valve head 240 is revolved around its main axis to close, the abutment 270, on which it sits, revolves with it, and makes the screw 220 to revolve as well. Depending on the number of turns, the screw 220 is spirally pushed down inside the open top, hollow valve stem 120. This action is carried out until screw 220 is fully inserted into the valve stem 280, reaches the valve plate 220 and closes on it. Spring 230 wraps around screw 220 and is locked between the bottom surface of the abutment 270 and a recess 280a at the top part of the valve stem 280. This recess 280a is essentially formed due to a thickness difference between the top lower parts of the valve stem. When screwing down screw 220 into and inside the valve stem, spring 230 contracts under the pressure that the valve head 240 applies on the abutment 270. The spring constant and length and dimensions of spring 230 are configured, so that its contraction is coordinated with the screwing down of screw 230 until reaching the valve plate 250. This action essentially locks the bottom seat 210 over the top opening of the lower barrel 110 of the fire hydrant 100, thereby pushing back against water that flows from the water main through the hydrant base 135 and into the bottom barrel 110. As a result, water is blocked from flowing inside the hydrant and out through the pamper outlet 120.

When revolving the valve head 240 to the opposite direction, the screw 220 is turned also to the opposite direction inside the valve stem 280 and releases its pressure on the valve plate 250. The spring 230 also stretches back to a relaxed state, depending on the number of revolutions of the valve head 240, but the screw is allowed to travel upwards until blocked at the top part of the hollow valve stem 280a. The disengagement of the valve plate 250 off of the bottom seat 210, combined with the solid separation of the valve and seat, result in the release of pressure that the valve plate 250 applies on the bottom seat 210, so that water flowing up inside the bottom barrel 110 of the hydrant 100 push against the bottom seat 210 and lift it up with the upward water pressure. The bottom seat 210 does not resist the flow of water inside the hydrant and out through pamper outlet 230. As a result, the flow of water out of the hydrant blocks any flow into it through the pamper outlet 120. This way, tampering with the water in the water main is prevented also when the hydrant valve is open.

The advantage here is twofold. Not any water, fluid or substance can be introduced into the hydrant and through it to the water main from the pamper outlet 120 in either the open and closed states of the hydrant. In the closed state, the bottom seat 210 tightly locks the opening of the lower barrel 110 and blocks any attempt of tampering through the pamper outlet 120. In the open state, the water pressure itself blocks inflow of fluids into the hydrant and the water main, due to the solid separation of the bottom seat 210 from the valve plate 250. When opening the valve, the spring 230 operates as a flexible, soft brake that absorbs the hit of the water pressure, as water flood the hydrant. This way the spring 230 protects the solid parts of the modular anti-tampering valve and prevents the valve stem 280 from hitting the abutment 270 above that holds that valve head 240.

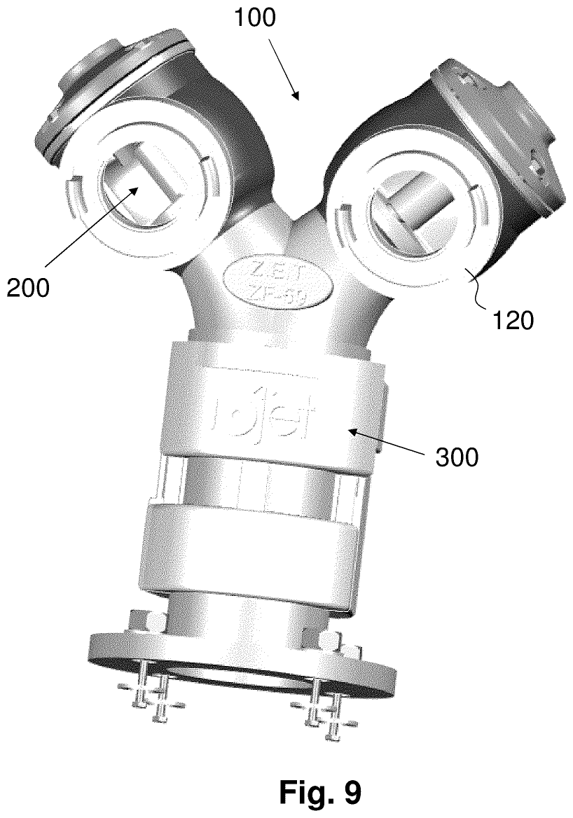

The diameter of the bottom seat 210 is fit to the spatial dimensions of the top opening 130 of the lower barrel 110 of the hydrant 100, so that the edge of the top opening 130 (see FIG. 10) blocks the seat 210 from sliding or being pushed down into the lower barrel 110 of the hydrant. The lower valve plate 210 is coated with an elastic sealing material such as rubber The screw 220 has a diameter and threading that complement the hollow volume of the open top stem valve 280. The spring 230 is placed around the thread bore and above and between the abutment 270 of the valve head 240 and recess of at the top part 280a of the hollow valve stem 280. The spring 230 contracts when the screw 220 is screwed into the valve stem 280 and expands when the screw is released. In current hydrants the bottom seat, screw and and valve stem are made as a solid unit, so that the seat is lifted when the valve is opened. As a result, the water can flow in both directions in and out of the hydrant, which exposes the hydrant to tampering and steeling of water. In the modular non-return valve of the present invention, the screw is disconnected from the bottom seat and in operative connection with the valve stem, so the valve may open as the screw is unscrewed from the thread bore without lifting the bottom seat. Such modular connection between the screw and bottom seat keeps the seat at the bottom, where the seat blocks access to the interior of the hydrant from its pamper outlet 120. In such configuration, the mechanical pressure of the screw on the bottom seat is released and the seat may open only by the pressure of water that streams from the water main through the bottom of the hydrant and out of the pamper outlet. Backflow of fluids into the hydrant through the exit is now blocked by the separate bottom seat even when the screw is lifted up and the valve is open. This is because the water, which is streamed through the exit, presses the seat on the aperture of the bottom of the hydrant and prevents backflow of fluids into the municipal water pipe system. Streaming of fluids that contain hazardous materials is now impossible, because either the water flowing out through the exit prevents it or the seat blocks the lower barrel 110 of the hydrant and the passage to the opening when no water flows out.

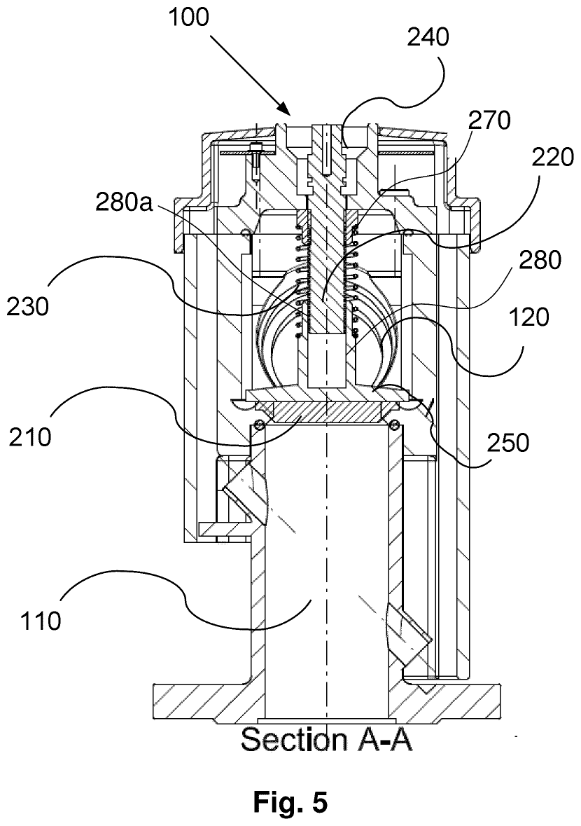

FIG. 6 illustrates a side cross-section of the fire hydrant that shows the different parts of the valve with the anti-tampering mechanism. The bottom seat 210 is shown to block water flow from the bottom, which is connected to the municipal water pipe system, when the screw closes on the valve plate. Water pressure flowing from the water main through the base 135 lifts the bottom seat 210 up and opens the passage from the lower barrel 110 to the pamper outlet 120, when the screw is screwed back by the valve head.

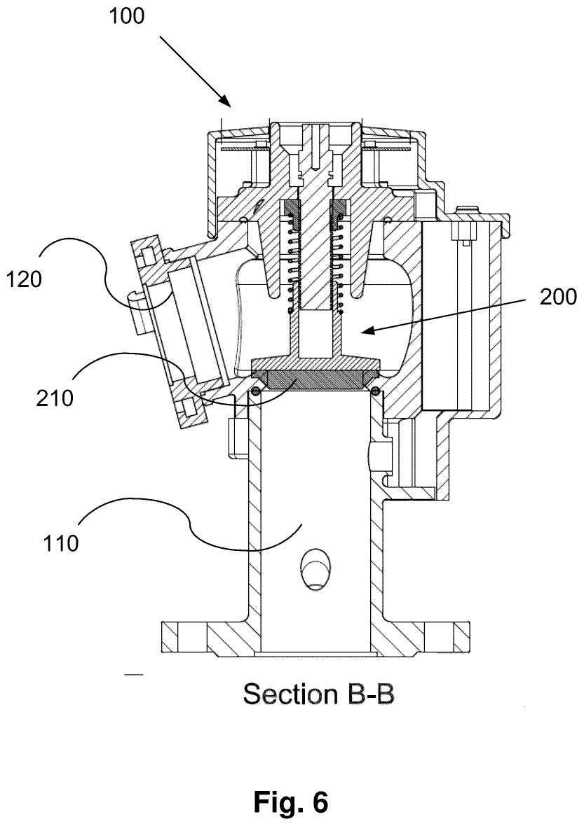

FIG. 7 illustrates a top view of the fire hydrant with the part of the valve anti-tampering mechanism that connects to the screw 220. The valve head 240 connects to the top of the hydrant and screws and unscrews the screw 220 as it closes and opens the hydrant respectively.

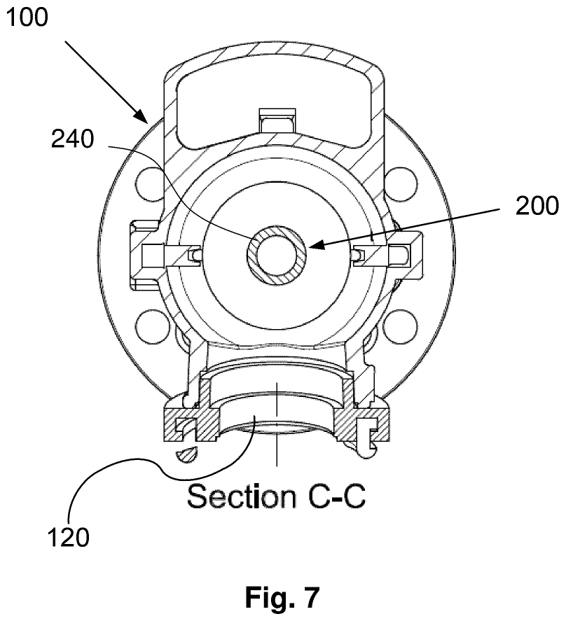

FIG. 8 illustrates a top cross section of the anti-tampering mechanism at the location in the fire hydrant that accommodates it. The cover of the hydrant carries the valve head that screws and unscrews screw 220 inside the open top, hollow valve stem.

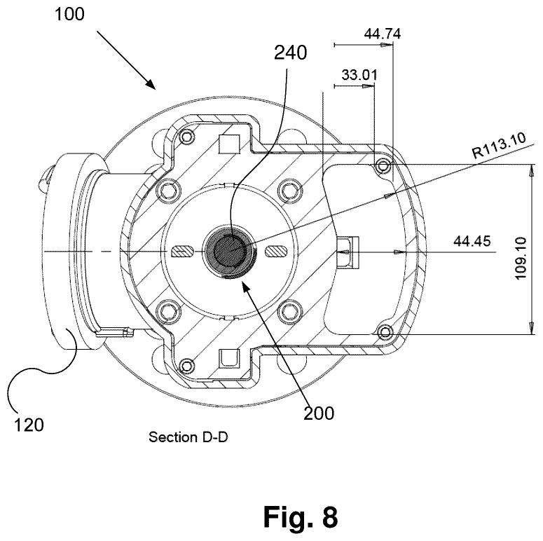

FIG. 9 shows a 3D illustration of a fire hydrant comprising anti-tampering, anti-theft mechanisms of the present invention. The fire hydrant 100 comprises the valve with the anti-tampering mechanism 200 within bonnet 190 and under cap 180, and an anti-theft mechanism in its housing 300 surrounding the lower barrel of the hydrant. FIG. 10 further shows partly exploded view of this fire hydrant with the different parts of valve with the anti-tampering mechanism 200. These parts and their functionalities have been described above in more detail with reference to FIG. 5.

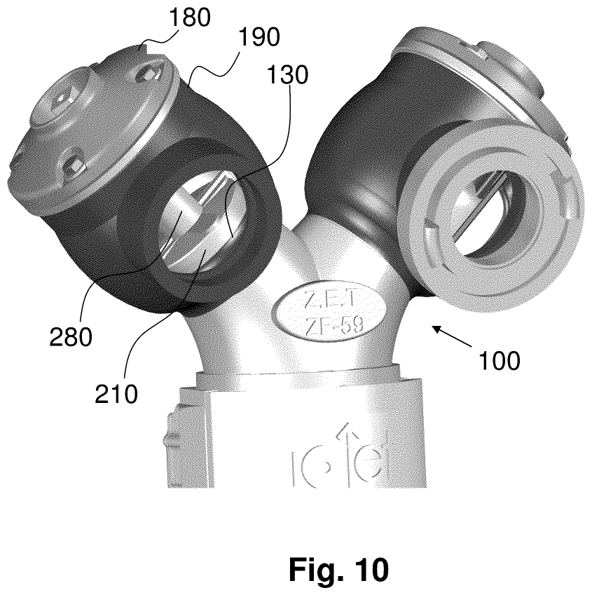

FIGS. 11-13 show 3D illustrations of the parts of the case 300 that contains the anti-theft mechanism, where the case is mounted on the outer side of the lower barrel of the hydrant. Essentially, the case comprises two parts 310 and 320 that wrap around the lower barrel 110 of the hydrant. The back 320 of the case comprises a volume sufficient to accommodate the fluid flow sensors in the hydrant, wireless transmitters for transmitting the information collected by the sensors to a distant wireless receiver through a local area network, world wide web network or cellular network and electronics. Such receiver may be a cellular phone, a laptop, a tablet, an i-pad and a desktop computer. The case itself is protected against tampering and alerts on attempts to compromise it and damage the sensor and wireless transmittance equipment and electronics.

It should be noted that the anti-tampering mechanism of the invention may adjusted and implemented to different types of devices in which water or any other type of fluid flows. The application in a fire hydrant is exemplary and should not be construed as limiting the scope of the invention solely to such application. The same applies to the anti-theft means, which may be mounted on different types of water or fluid delivery means and devices.

1. An anti-tampering mechanism for a fire hydrant, said mechanism comprising:
a valve head;
a screw in solid communication with said valve head;
an open top hollow, valve stem configured to complement size and threading of said screw;
a valve plate at lower end of said open top, hollow valve stem and in solid communication with said valve plate;
a bottom seat below said valve plate and in mechanical engagement and disengagement contact with said open top, hollow valve plate; anda spring surrounding said screw and in mechanical communication with an abutment below said valve head on one end and with said open top, hollow valve stem, wherein said anti-tampering mechanism is configured to block water inflow from pamper outlet into lower barrel of said fire hydrant in closed state of said valve head by locking said bottom seat to top opening of said lower barrel with said screw and valve stem and plate, and with upstream water pressure from water main through said lower barrel and out through said pamper outlet.

2. The anti-tampering mechanism according to claim 1, wherein said bottom seat is configured to be lifted off of top opening of said lower barrel of said fire hydrant only by upstream water flow from a water main to which said hydrant is connected and through lower barrel of said fire hydrant and out of said pamper outlet, wherein the bottom seat blocks inflow of fluids from said pamper outlet of said fire hydrant into said lower barrel.

3. The anti-tampering mechanism according to claim 1, wherein said abutment is configured to press against upper end of said spring, wherein upper part of said open top, hollow valve stem comprises a recesses for accommodating and locking bottom end of said spring.

4. The anti-tampering mechanism according to claim 3, wherein said spring expands upon screwing said screw into said open top, hollow valve stem and closing said valve and contracts upon releasing said screw off of said open top, hollow valve stem.

5. The anti-tampering mechanism according to claim 4, wherein said spring is configured to absorb pressure from water flow upstream inside said lower barrel and out to said pamper outlet and prevent hitting of solid parts of said anti-tampering mechanism.

6. The anti-tampering mechanism according to claim 1, further comprising a sealer ring in a recess in said valve head and an O-ring in a recess between said valve head and said screw.

7. The anti-tampering mechanism according to claim 1, further comprising a sealer ring between said bottom seat and top opening of said lower barrel.

8. The anti-tampering mechanism according to claim 1, further comprising an anti-theft mechanism for a fire hydrant, said anti-theft mechanism comprising:
water flow sensors for external monitoring of water flow in said water conducting channel, said water flow sensors comprising controllers for controlling and supervising operation of said water flow sensors;
a communication module for wirelessly communicating signals from said water flow sensors to a remote control unit; and
a housing for accommodating said water flow sensors and communication module and protectively enveloping them against tampering, vandalism and sabotaging.

9. The anti-tampering mechanism according to claim 8, wherein said anti-theft mechanism further comprises a controller for controlling and supervising operation of said water flow sensors.

10. The anti-tampering mechanism according to claim 9, further comprising a water flow monitoring device comprising:
ultrasonic sensors for external monitoring of water flow in a fire hydrant, said ultrasonic sensors comprising controllers for controlling and supervising operation of said water flow sensors;
communication module for wirelessly communicating signals from said ultrasonic sensors to a remote control unit; and
a housing for accommodating said ultrasonic sensors and communication module and protectively enveloping them against tampering, vandalism and sabotaging.

11. The anti-tampering mechanism according to claim 10, wherein said water flow monitoring device comprises a controller for controlling and supervising operation of said ultrasonic sensors.

12. The anti-tampering mechanism according to claim 8, wherein said housing is made of composite material.

13. The anti-tampering mechanism according to claim 12, wherein said composite material comprises fiberglass and polyester.

14. The anti-tampering mechanism according to claim 12, wherein said composite material further comprises additives selected from plasticizers, softeners, UV absorbers, static charge neutralizing fillers and flame retardants.

15. The anti-tampering mechanism according to claim 8, further comprising electro-mechanical switches attached to said screws of said housing.

16. The anti-tampering mechanism according to claim 8, wherein said housing is fabricated form martial which is partially or fully transparent to cellular and wireless short wavelength communication ranges.

17. The anti-tampering mechanism according to claim 8, wherein said water flow sensors are non-invasive sensors.

18. The anti-tampering mechanism according to claim 17, wherein said non-invasive sensors are ultrasonic sensors installed on outer surface of said water conducting channel.

19. The anti-tampering mechanism according to claim 8, wherein said water flow sensors are invasive sensors.

20. The anti-tampering mechanism according to claim 19, wherein said invasive sensors are selected from visual or IR camera, said camera is configured to be introduced into volume of said water conducting channel and monitor water flow.
